(19) United States
(12) Patent Application Publication
(10) Pub. No.: US 2006/0283220 A1
(43) Pub. Date: Dec. 21, 2006

(54) System and process for high efficiency composting

(75) Inventor: William H. Moss, Coral Springs, FL (US)

Correspondence Address: DUANE MORRIS, LLP;IP DEPARTMENT, 30 SOUTH 17TH STREET, PHILADELPHIA, PA, 19103-4196, US

(73) Assignee: NutraCycle LLC

(21) Appl. No.: 11/145,434

(22) Filed: Jun. 3, 2005

(51) Int. Cl. C05F 11/08

(52) U.S. Cl. 71/6

(57) ABSTRACT

The present invention improves upon conventional composting by adding a dryer to the system to evaporate moisture. In the high efficiency composting process of the present invention, recycled, dehydrated compost material replaces the bulking agent to adjust the moisture of material entering the fermentor. The invention results in a substantial volume reduction of the fermentor.

### FIELD OF THE INVENTION

The present invention relates to composting of animal manure, poultry manure, and/or sewage sludge from municipal wastewater treatment plants. Specifically, the present invention relates to a method of composting with less time and cost for processing, less land, and a superior form of final product, the final form being a dehydrated pellet or granule approaching 100% dehydrated, composted manure or 100% dehydrated, composted sewage sludge. The high quality dehydrated compost can be used in automated fertilizer spreading machines and common bulk material handling equipment for loading, unloading, storage and transport.

### BACKGROUND OF THE INVENTION

Composting is the aerobic decomposition of manure or other organic materials in a thermophilic temperature range (about 40-65° C.). Composting improves the handling characteristics of organic residues by reducing their volume and weight. Composting also converts organic material to a stable material that is not harmful to soil, plants, or crops. Some of the disadvantages of composting organic residues include time for processing, cost for handling equipment, and available land for composting.

Water content is an important factor influencing the rate and efficiency of composting. Moisture content between about 40% and 60% is a useful target range, with moisture needed for microbial activity. Water is required to allow chemical reactions to proceed, as well as to transport nutrients and allow microorganisms to move within the compost window. However, excessive moisture inhibits gas exchange, slowing down decomposition, and possibly resulting in anaerobic conditions; when moisture levels are too low, microbial activity is less rapid.

Some homogeneous organic materials can be composted alone without mixing with bulk materials. However, very wet raw materials, particularly animal manure and sewage sludge, need to have the moisture reduced to below about 60% before composting. The moisture content for materials entering most industrial dryers should be less than about 50%, and preferably in the range of about 20-30% moisture. Direct drying of very wet material is not practical; instead of drying, a dry bulking material is added in conventional composting, in order to absorb moisture until the ideal moisture target, about 40-60% moisture, is achieved. Bulking agents provide structural support when manure solids, or other organic residues, are too wet to maintain air spaces within the composting pile. Dry and fibrous materials, such as sawdust, leaves, finely chopped straw or peat moss, are good bulking agents for composting wet manure or organic residues.

U.S. Pat. No. 3,905,796 (the '796 patent) teaches a process for dehydrating manure-based fertilizers where a homogenous and durable pulp is granulated and dried. The '796 patent notes that manure undergoes a first fermentation in the course of storage, but does not describe the extent of fermentation or the method (time, temperature, moisture, passive or active turning of the material, etc.). The '796 patent describes mixing of pre-dried material with wet material in order to prepare for granulation.

U.S. Pat. No. 4,082,532 discloses a process for manufacturing extruded cattle manure pellets where the cattle manure is mixed into a pulp and contains moisture content between 50 to 55% by weight. The material is extruded to form strands, which are subsequently dried in a fluidized bed. The dried manure pellets are not fermented. The organic products in manure have to be converted to inorganic form before they can be used as organic fertilizer. Dried manure products that are not fermented are potentially harmful to growing plants or crops.

U.S. Pat. No. 6,372,007 (the '007 patent) describes a general process for making compost from bovine manure, where additional ingredients are added to make a complete, balanced organic fertilizer. The '007 patent describes the fermentation process as a traditional composting process where bovine manure is spread on the ground and turned. After fermentation, the manure is air dried by spreading. Any fermentation and drying process using land spreading and air drying requires a large land area, extensive handling, and is very time-consuming.

U.S. Pat. No. 6,648,940 (the '940 patent) describes a process for producing compost by adding seed bacteria to accelerate the process. Yagihashi's process is specific for processing organic waste materials from food processing factories, including spent grains from beer factories, fish cake from fish processing factories, and soybean pulp from bean curd production, where water content ranges from 55-70%. The addition of seed bacteria reduces the fermentation processing time from several months to thirty days. The effectiveness of the process depends upon highly regulated moisture control (60%) and oxygen concentration in the compost at 15-21%.

### SUMMARY OF THE INVENTION

The present invention improves upon conventional composting by adding a dryer to the system to evaporate moisture. In the high efficiency composting process of the present invention, recycled, dehydrated compost material replaces the bulking agent to adjust the moisture of material entering the fermentation vessel (fermentor). The invention results in a substantial volume reduction of the fermentor.

### BRIEF DESCRIPTION OF THE DRAWINGS

FIG. 1 is a flowchart diagram of an exemplary process of the present invention;

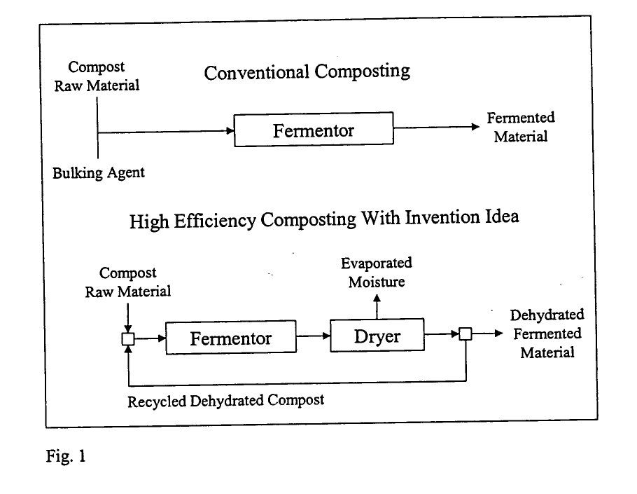

FIG. 2 is a flowchart diagram of a conventional fermentor;

FIG. 3 is an additional flowchart diagram of the high efficiency composting process of the present invention;

FIG. 4 is a flowchart diagram of a conventional continuous fermentor modeled with biomass conversion and evaporation losses; and

FIG. 5 is a flowchart diagram of the high efficiency composting process of the present invention, modeled with biomass conversion and evaporation losses.

### DETAILED DESCRIPTION OF THE INVENTION

The fermentor operating conditions for the high efficiency composting process of the present invention are similar to conventional composting. The moisture of the material entering the fermentor is adjusted to approximately 40% to 60%, and the operating temperature of the fermentor is about 40-65° C., which is in the thermophilic range.

An additional advantage of the high efficiency composting process of the present invention is that the dehydrated, fermented material can be formed into a pellet or granule by any method known in the art. Dehydrated pellets or granules can be used in automated fertilizer spreading machines and common bulk material handling equipment for loading, unloading, storage and transport.

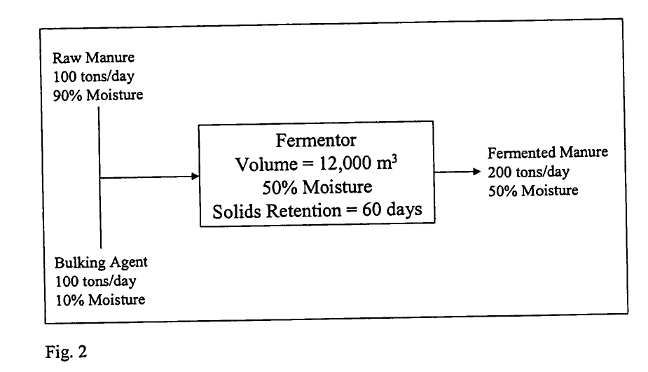

In comparing the relative size of a conventional composting fermentor with the size of a fermentor using the high efficiency composting process for composting 100 tons/day of raw manure (FIG. 2), for the conventional composting fermentor, the feed is 100 tons/day of raw manure at 90% moisture. One hundred tons/day of bulking agent (e.g., sawdust) at 10% moisture is added so that the fermentor has 50% moisture. Assuming that the density is one ton/m³, the fermentor volume is 12,000 m³, for a compost time of 60 days. The average residence time for solids in the fermentor=(Solids in the fermentor)/(Solids exiting the system)=(12,000 m³*1 m³/ton*50%)/(200 tons/day*50%)=(12,000*0.5)/(200*0.5)=60 days.

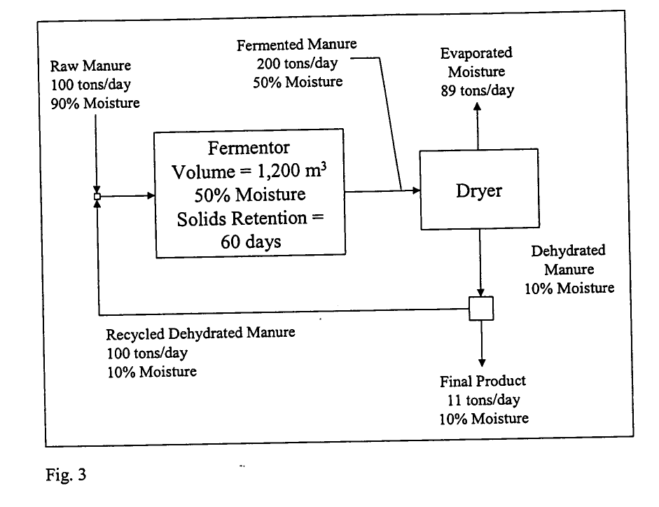

Referring to FIG. 3, for the high efficiency composting process of the present invention, the feed is the same at 100 tons/day of raw manure at 90% moisture. Instead of bulking agent, one hundred tons/day of recycled, dehydrated manure at 10% moisture is added, so that the fermentor has 50% moisture. The recycled, dehydrated pig manure is product exiting the dryer. Assuming that the density is one ton/m³, the fermentor volume is 1,200 m³, for a compost time of 60 days. The average residence time for solids in the fermentor=(Solids in the fermentor)/(Solids exiting the system)=(1,200 m³*1 m³/ton*50%)/(11 tons/day*90%)=(1,200*0.5)/(11*0.9)=60 days.

The relative size of the fermentors=(12,000 m³)/(1,200 m³)=10:1. Thus, the conventional fermentor is 10 times the volume of the fermentor using the high efficiency composting process of the present invention. In terms of loss of solids (microbiological degradation of organic carbon to CO₂) and evaporative moisture loss, the relative volume ratio is even more favorable for the high efficiency composting process of the present invention.

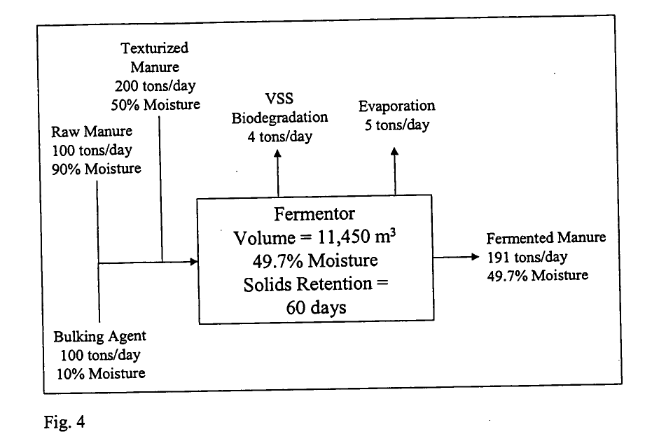

Referring to FIG. 4, for the conventional composting fermentor, the feedstock is 100 tons/day of raw manure at 90% moisture. One hundred tons/day of bulling agent (e.g., sawdust) at 10% moisture is added so that the material entering the fermentor has 50% moisture. Assuming that the density is one ton/m³, the moisture loss is 5% of the incoming moisture (or 5 tons/day), and the bioconversion of organic carbon to CO₂ is 40% of the incoming manure solids (or 4 tons/day), the fermentor volume is 11,450 m³, for a compost time of 60 days. The average residence time for solids in the fermentor=(Solids in the fermentor)/(Solids exiting the system)=(11,450 m³*1 m³/ton*50.3%)/(191 tons/day*50.3%)=(11,450*0.503)/(191*0.503)=60 days.

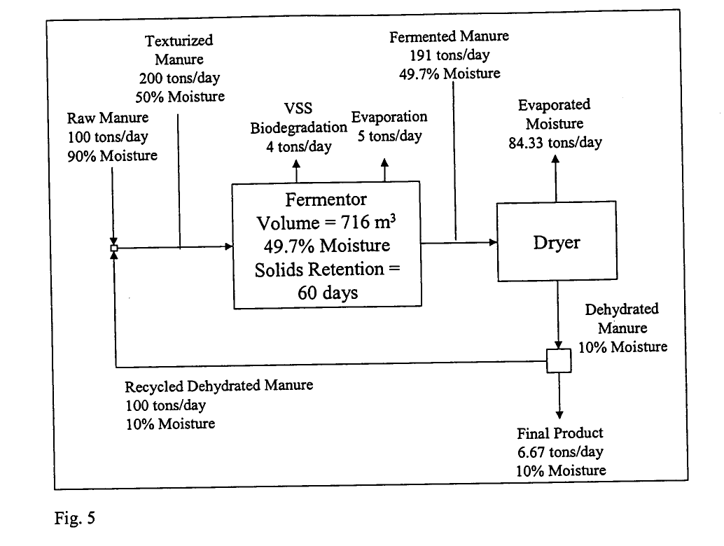

Referring to FIG. 5, for the composting fermentor using the process of the present invention, the feedstock is the same at 100 tons/day of raw manure at 90% moisture. Instead of bulring agent, one hundred tons/day of recycled dehydrated pig manure at 10% moisture is added, so that material entering the fermentor has 50% moisture. The recycled, dehydrated manure is product exiting the dryer. Assuming that the density is one ton/m³, the moisture loss is 5% of the incoming moisture (or 5 tons/day), and the bioconversion of organic carbon to CO₂ is 40% of the incoming manure solids (or 4 tons/day), the fermentor volume is 716 m³, for a compost time of 60 days. The average residence time for solids in the fermentor=(Solids in the fermentor)/(Solids Exiting the system)=(716 m³*1 m³/ton*50.3%)/(6.67 tons/day*90%)=(716*0.503)/(6.67*0.9)=60 days.

Note that the fermentor in the process of the present invention is an order of magnitude smaller than a fermentor in a conventional composting process that requires addition of a bulking agent. The final product produced by the process of the present invention eliminates the problems associated with the cost of transportation of a humid material as well as problems of handling, storage and labor. In addition, the final product produced by the process of the present invention is a dehydrated pellet or granule that can be used in automated fertilizer spreading machines and common bulk material handling equipment for loading, unloading, storage and transport.

The final product produced by the process of the present invention is virtually 100% pure raw material that has been fermented and dehydrated. Pure, 100% composted livestock manure has more economic value than composted products that have been mixed with bulking agents (that is, compost made with less than 100% livestock manure).

While the present invention has been described with respect to particular embodiments thereof, it is apparent that numerous other forms and modifications of the invention will be obvious to those skilled in the art. The appended claims and the present invention generally should be construed to cover all such obvious forms and modifications which are within the true spirit and scope of the present invention.

What is claimed is:

1. A process for producing compost material in a fermentation vessel which comprises (a) introducing compost material with a moisture content of from about 40-60% into the vessel, and (b) employing a dryer to evaporate additional moisture from the compost material, resulting in a dehydrated, fermented compost material with a moisture content of from about 5% and 15%.

2. The process as recited in claim 1, wherein the dehydrated, fermented compost material is mixed with animal manure or sewage solids to adjust the moisture of material entering the vessel to from about 40% and 60%.

3. The process as recited in claim 1, wherein the dehydrated, fermented compost material contains approximately 100% animal manure or sewage solids, without other additives.

4. The process as recited in claim 1, wherein the compost material is selected from the group consisting of animal manure, poultry manure, and sewage sludge.

5. The process as recited in claim 1, wherein said dehydrated, fermented compost material is suitable for use as a fertilizer.

6. The process as recited in claim 1, wherein the average residence time for solids in the vessel is an order of magnitude higher than the calculated detention time of the vessel.

7. A process for producing compost material in a fermentation vessel which comprises (a) introducing compost material with a moisture content of from about 40-60% into the vessel, and (b) employing a dryer to evaporate additional moisture from the compost material, wherein recycled, dehydrated compost material replaces a bulking agent to adjust the moisture of material entering the vessel.

8. The process as recited in claim 7, wherein the dehydrated, fermented compost material is mixed with animal manure or sewage solids to adjust the moisture of material entering the vessel to from about 40% and 60%.

9. The process as recited in claim 7, wherein the dehydrated, fermented compost material contains approximately 100% animal manure or sewage solids, without other additives.

10. The process as recited in claim 7, wherein the compost material is selected from the group consisting of animal manure, poultry manure, and sewage sludge.

11. The process as recited in claim 7, wherein said dehydrated, fermented compost material is suitable for use as a fertilizer.

12. The process as recited in claim 7, wherein the average residence time for solids in the vessel is an order of magnitude higher than the calculated detention time of the vessel.
